(19) United States
(12) Patent Application Publication
(10) Pub. No.: US 2007/0139377 A1
(43) Pub. Date: Jun. 21, 2007

(54) Cursor control device

(75) Inventors: Hsiao-Lung Chiang, Taipei (TW); Yu-Chih Cheng, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/365,776

(22) Filed: Mar. 1, 2006

(30) Foreign Application Priority Data
Dec. 16, 2005 (TW) 094144630

(51) Int. Cl. G09G 5/08

(52) U.S. Cl. 345/163

(57) ABSTRACT

A cursor control device for use with a computer system includes a main body, a scroll wheel assembly and a tilt sensing module. The scroll wheel assembly is disposed within the main body, and operable to move in a vertical direction and tilt toward a first tilt direction. The tilt sensing module is disposed within the main body and comprises a first triggering element and a first tilt sensor. The first triggering element is disposed above the first tilt sensor. On one hand, the first triggering element is kept at least a certain clearance from the scroll wheel assembly even when the scroll wheel assembly is moved in the vertical direction. On the other hand, the clearance is shrunk when the scroll wheel assembly is tilted toward the first tilt direction to touch the first triggering element so as to trigger the first tilt sensor.

### FIELD OF THE INVENTION

The present invention relates to a cursor control device, and more particularly to a cursor control device for use with a computer system to control movement of a cursor bar shown on a window of the computer's operation system.

### BACKGROUND OF THE INVENTION

Nowadays, computers become essential data processing apparatuses in the digitalized and electronic societies. For helping the user well operate the computer system, the hardware and the software associated with the computer system are developed in views of humanization and user-friendliness. For example, when the software is running in the Windows or Linux environment, graphic-based operation systems are widely used. The user operation interface for hardware usually includes an essential keyboard and optionally a pointing device. An exemplary pointing device is a mouse for executing data processing operations in the graphic-based operation system therevia, thereby exempting from the complicated procedures of inputting instructions or program languages.

In the early stage, the mouse is designed on the basis of the functionality and utility thereof. With increasing demand of using the mouse as control device of the computer system, the mice having a variety of functions and hardware configurations are designed and associated technologies are well established. For example, the mechanism for sensing the moving direction and the displacement of the mouse is shifted from a trackball mechanism to an optical sensing mechanism. Furthermore, the method for transmitting signals is advanced from the wired signal transmission technology to the wireless transmission technology. For practicability, the number of buttons is changed from three to two. In addition to these two mouse buttons, a wheel assembly is also used for scrolling an image.

Referring to FIG. 1(a), a schematic view of a scroll wheel type mouse 10 is illustrated. The scroll wheel type mouse 10 includes a scroll wheel 14 arranged between two click buttons 12A and 12B and rotatable along a rotating shaft 11 indicated as the dashed line. The scroll wheel 14 of the mouse 10 can be rotated forwardly or backwardly as shown in the arrows 16, thereby scrolling the image shown on the display screen upwardly and downwardly. Generally, the graphic-based operation system allows representation of the window including graphs or texts, for example a web page, a document or a trial balance. In a case that a web page, a document or a trial balance has a length more than one page, the whole data fail to be simultaneously shown on the display screen. By rotating the scroll bar beside the window, the image displayed on the display screen would be scrolled upwardly or downwardly in order to be browsed. Likewise, according to the rotating degree of the scroll wheel 14 of the mouse 10, the scroll bar beside the window of a web page, a document or a trial balance is quickly scrolled in the vertical direction, so that the image displayed on the window of the display screen would be scrolled upwardly or downwardly.

For increasing convenience, in addition to the click buttons 12A and 12B, the scroll wheel 14 of the mouse 10 is replaced with a third button. The third button has the functions of the click button and the scroll wheel and is also referred as a wheel button. The outward appearance of this wheel button 14 is similar to that shown in FIG. 1(a). On one hand, the wheel button 14 may be rotated forwardly and backwardly. On the other hand, like the click buttons 12A and 12B, the wheel button may be moved vertically. For example, if the wheel button 14 is pressed down and the mouse 10 is slightly moved in a certain direction, the speed for scrolling the scroll bar beside the window or browsing the web page or the document is increased, so that the user needs not continuously rotate the wheel button 14. Moreover, the specified mouse driver should be installed in the computer system and then the functions of the wheel button are set by software.

In addition to the vertical scroll movement, it is important to achieve the horizontal scroll movement. For example, since the texts or graphs contained in a target area of the graphic-based window sometimes need to be scaled up, the horizontal scroll movement is required to move the web page or the document in the left or right direction so as to display the desired image according to the user

Referring to FIG. 1(b), a schematic view of a tilt wheel type mouse 20 is illustrated. The tilt wheel type mouse 20 is developed in combination of the wheel button technology and the tilt wheel technology. The tilt wheel type mouse of FIG. 1(b) is disclosed in Taiwanese Patent Application No. 092,136,834, entitled “A pointing device for scrolling an image in multiple directions”, and which is hereby fully incorporated by reference. The scroll wheel 24 of the mouse 20 can be rotated forwardly or backwardly as shown in the arrows 26 along a rotating shaft 21, thereby scrolling the image shown on the display screen upwardly and downwardly. The scroll wheel 24 is supported on a base 23. The base 23 is movable vertically with the movement of the scroll wheel 24. The base 23 comprises two triggering ends 25A and 25B at bilateral sides thereof and another triggering end 25C at the front end thereof. When the scroll wheel 24 is pressed down, a knock sensor 260 is triggered by the triggering end 25C of the base 23, so that the functions of the wheel button are enabled. A first tilt sensor 27A is arranged between the base 23 and a left click button sensor 22A. Likewise, a second sensor 27B is arranged between the base 23 and a right click button sensor 22B. As known, the left click button sensor 22A and the right click button sensor 22B are triggered when the left click button and the right click button are respectively pressed down. When the base 23 is moved downwardly to contact with the triggering ends 25A and 25B, the first tilt sensor 27A and the second tilt sensor 27B are triggered, respectively, so that the functions of the tilt wheel are enabled.

Please refer to FIGS. 1(c) and 1(d), which are schematic views illustrating the approaches for activating the functions of the tilt wheel of the tilt wheel type mouse 20. In FIG. 1(c), after the scroll wheel 24 is pressed down and the functions of the wheel button are enabled, the scroll wheel 24 is then tilted toward the left side as shown in the arrows 28 with the tilt shaft 29 serving as a pivoting axis. Meanwhile, the tilt sensor 27A is triggered to enable the function of the tilt wheel, and thus the scroll bar beside the window of the web page or the document is continuously scrolled leftwards. Likewise, as shown in FIG. 1(d), after the scroll wheel 24 is pressed down and the functions of the wheel button are enabled, the scroll wheel 24 is then tilted toward the right side as shown in the arrows 28 with the tilt shaft 29 serving as a pivoting axis. Meanwhile, the tilt sensor 27B is triggered to enable the function of the tilt wheel, and thus the scroll bar beside the window of the web page or the document is continuously scrolled rightwards. Therefore, by rotating the scroll wheel 24, the image displayed on the window of the display screen would be quickly scrolled in the vertical direction. Moreover, by tilting the scroll wheel 24, the image displayed on the window of the display screen would be quickly scrolled in the horizontal direction.

Although the tilt wheel type mouse 20 is useful to effortlessly navigate continuous pages, there are still some drawbacks. For example, when the scroll wheel 24 is pressed down to trigger the knock sensor 260, if the depressing force applied onto the scroll wheel 24 is improperly tilted, the first tilt sensor 27A or the second tilt sensor 27B is likely to be simultaneously triggered. Under this circumstance, the mouse 20 is subject to an erroneous operation. In other words, as shown in FIGS. 1(c) and 1(d), due to the precise design of the related components, the clearance between the triggering end 25A (or 25B) and the tilt sensor 27A (or 27B) is very tiny after the base 23 is shifted downwardly. Therefore, the user fails to well know whether the scroll wheel 24 is tilted leftwards or rightwards, so that the possibility of causing erroneous contact with the tilt sensor 27A or 27B is increased.

In views of the above-described disadvantages resulted from the prior art, the applicant keeps on carving unflaggingly to develop a cursor control device according to the present invention through wholehearted experience and research.

### SUMMARY OF THE INVENTION

It is an object of the present invention to provide a cursor control device for avoiding erroneous operation of the scroll wheel caused by the mutual interference between the vertical operation and the horizontal operation.

In accordance to an aspect of the present invention, there is provided a cursor control device for use with a computer system. The cursor control device comprises a main body, a scroll wheel assembly and a tilt sensing module. The scroll wheel assembly is disposed within the main body, and operable to move in a vertical direction and tilt toward a first tilt direction. The tilt sensing module is disposed within the main body and comprises a first triggering element and a first tilt sensor. The first triggering element is disposed above the first tilt sensor. On one hand, the first triggering element is kept at least a certain clearance from the scroll wheel assembly even when the scroll wheel assembly is moved in the vertical direction. On the other hand, the clearance is shrunk when the scroll wheel assembly is tilted toward the first tilt direction to touch the first triggering element so as to trigger the first tilt sensor.

In an embodiment, the cursor control device according to claim 1 further comprises a movement sensing module, a click button module and a processing control module. The movement sensing module is disposed within the main body, and has an optical or trackball type displacement sensor for detecting the displacement data of the main body relative to a smooth plane, thereby generating a movement sensing signal. The click button module comprises at least one click button and at least one click button sensor, wherein the at least one click button sensor is triggered when the corresponding click button is pressed down. The processing control module is disposed within the main body, and communicable with the scroll wheel assembly, the tilt sensing module, the movement sensing module, the click button module and the computer system. The scroll wheel assembly, the tilt sensing module, the movement sensing module and the click button module are actuated to issue corresponding signals to the processing control module. In response to the signals, the processing control module performs corresponding signal processing operations so as to control a cursor of the computer system.

In an embodiment, the scroll wheel assembly comprises a base, a scroll wheel and a rotation sensor. The base having a tilt shaft thereon. The tilt shaft includes a front end movably supported on a front supporting member of the main body and a rear end rear end movably embedded into a sliding slot of a rear supporting member of the main body, so that the base is movable in the vertical direction along the sliding slot of the rear supporting member and tilted toward the first tilt direction with the tilt shaft serving as a pivoting axis. The scroll wheel is disposed on the base, movable in the vertical direction with the base, and rotatable along a rotating shaft. The rotation sensor is supported on the base, and communicates with the processing control module to generate a rotation sensing signal according to the rotating degree of the scroll wheel. In response to the rotation sensing signal, the processing control module performs corresponding signal processing operation to control the cursor of the computer system.

In an embodiment, the cursor control device according to claim 1 further comprises a knock sensor and a resilient element. The knock sensor is disposed under the rear end of the tilt shaft and communicates with the processing control module. The resilient element is sustained between the rear end of the tilt shaft and the knock sensor to apply an upward resilient supporting force onto the base. A knock sensing signal is generated from the knock sensor when the base is moved and the knock sensor is triggered by the rear end of the tilt shaft. In response to the knock sensing signal, the processing control module performs corresponding signal processing operation to control the cursor of the computer system.

In an embodiment, the tilt sensing module is disposed at a side of the base where base is tilted toward the first tilt direction.

In an embodiment, the first triggering element is kept at least the certain clearance from the scroll wheel assembly allowing no touch between the base of the scroll wheel assembly and the first triggering element when the scroll wheel assembly is moved in the vertical direction.

In an embodiment, the first triggering element is disposed within the main body and has a triggering pin to touch the first tilt sensor under the first triggering element.

In an embodiment, the first triggering element is a flexible sheet deformed when the base is tilted toward the first tilt direction to touch the first triggering element. The first tilt sensor is triggered to generate a tilt sensing signal according to the degree of the first triggering element when the triggering pin of the first triggering element touches the first tilt sensor. In response to the tilt sensing signal, the processing control module performs corresponding signal processing operation to control the cursor of the computer system.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1(a) is a schematic outside view illustrating a scroll wheel type mouse according to prior art;

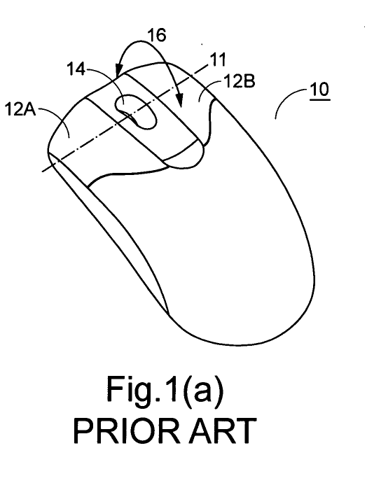

FIG. 1(b) is a schematic view illustrating the inner structure of a tilt wheel type mouse according to prior art;

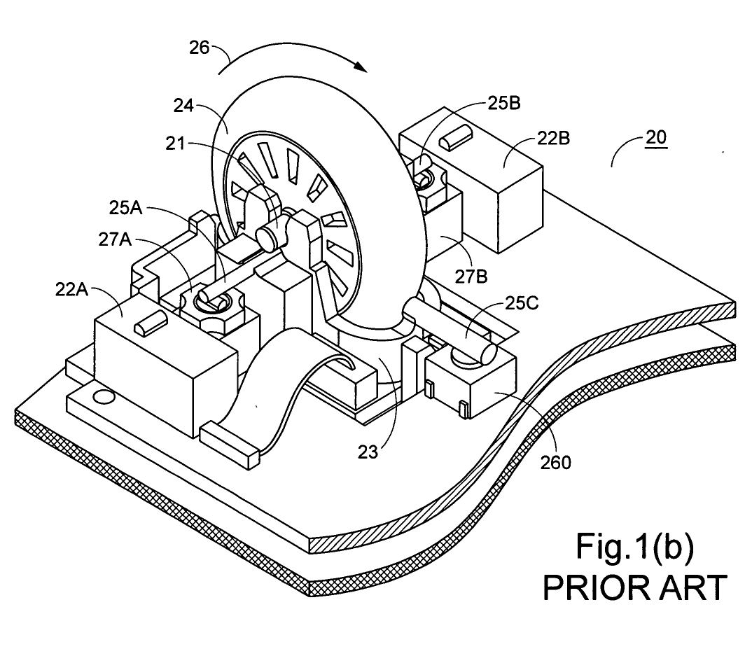

FIGS. 1(c) and 1(d), which are schematic views illustrating the approaches for activating the functions of the tilt wheel of the tilt wheel type mouse;

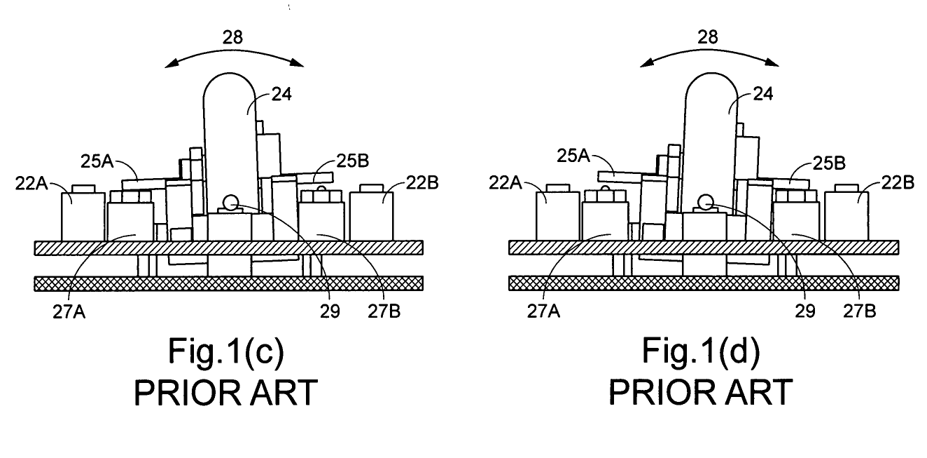

FIG. 2 is a schematic outside view illustrating a cursor control device according to a first preferred embodiment of the present invention;

FIG. 3 is a schematic exploded view partially illustrating the inner structure of the cursor control device of FIG. 2;

FIG. 4 is a schematic assembled view illustrating the inner structure of the cursor control device of FIG. 2;

FIG. 5 is a schematic assembled view of FIG. 4 taken from another viewpoint; and

FIG. 6 is a schematic front view illustrating the inner structure of the cursor control device of FIG. 2.

### DETAILED DESCRIPTION OF THE PREFERRED EMBODIMENT

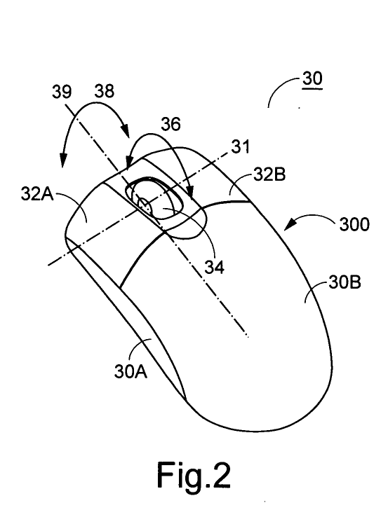

Referring to FIG. 2, a cursor control device 30 according to a first preferred embodiment of the present invention is illustrated. In FIG. 2, the exemplary cursor control device 30 is a tilt wheel type mouse, which includes a tilt wheel assembly having the functions of the wheel button and the tilt wheel. The cursor control device 30 of the present invention comprises a main body 300 composed of a lower housing 30A and an upper housing 30B. On the front edge of the upper housing 30B, two click buttons 32A and 32B are arranged on the left and right sides of a scroll wheel 34. The click buttons 32A and 32B are actuated to execute the same functions as the left and right buttons of the conventional mouse. The scroll wheel 34 is rotatable along a rotating shaft 31, which is disposed within the main body 300 and indicated as the dashed line. The scroll wheel 34 of the mouse 30 can be rotated forwardly or backwardly as shown in the arrows 36, thereby scrolling the image shown on the display screen upwardly and downwardly. The third button, which has the functions of the click button and the scroll wheel and is also referred as a wheel button, is actuated upon the scroll wheel 34 is pressed down. After the scroll wheel 34 is pressed down and the functions of the wheel button are enabled, the scroll wheel 34 is then tilted toward the left side as shown in the arrows 38 with the tilt shaft 39 serving as a pivoting axis. Meanwhile, the function of the tilt wheel is enabled, and thus the scroll bar beside the window of the web page or the document is continuously scrolled leftwards or rightwards.

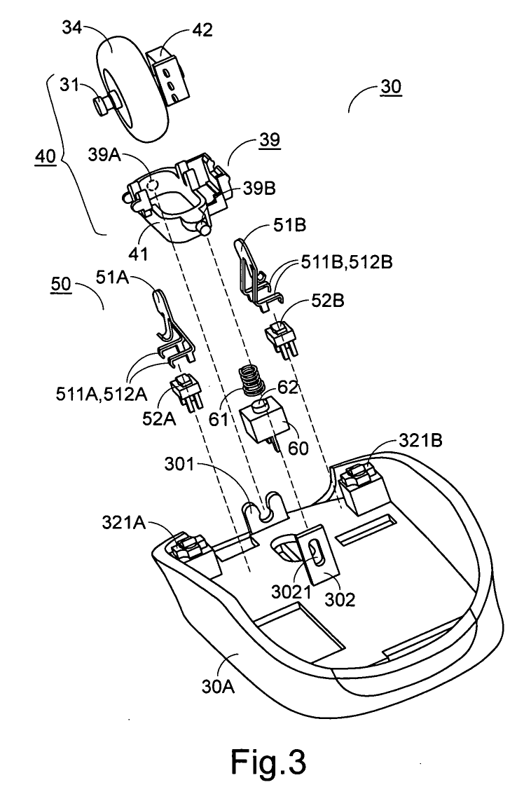

Please refer to FIG. 3, which is a schematic exploded view partially illustrating the inner structure of the tilt wheel type mouse 30. In the inner structure of the tilt wheel type mouse 30, a scroll wheel assembly 40, a tilt sensing module 50 and a knock sensor 60 are included to form the third click button. The scroll wheel assembly 40 comprises the scroll wheel 34, a base 41 and a rotation sensor 42. The scroll wheel 34 and the rotation sensor 42 are supported on a base 41. The scroll wheel 34 is rotatable along the rotating shaft 31. According to the rotating degree of the scroll wheel 34, a rotation sensing signal is generated from the rotation sensor 42.

As shown in FIG. 3, a front supporting member 301 and a rear supporting member 302 are protruded from the inner surface of the lower housing 30A. The tilt shaft 39 is also supported on the base 41 and includes a front end 39A and a rear end 39B. The front end 39A of the tilt shaft 39 is movably supported on a circular notch structure of the front supporting member 301, so that the front end 39A of the tilt shaft 39 can be shifted in the left or right direction. The rear end 39B of the tilt shaft 39 is movably embedded into a sliding slot 3021 of the rear supporting member 302, so that the base 3021 is movable vertically with respective to the lower housing 30A upon the tilt shaft 39 is moved along the sliding slot 3021 of the rear supporting member 302.

The knock sensor 60 is fixed on the lower housing 30A and under the rear end 39B of the tilt shaft 39. A resilient element 61 such as a spring is sheathed around a top button 62 of the knock sensor 60, and sustained between the rear end 39B of the tilt shaft 39 and the knock sensor 60. When the top button 62 of the knock sensor 60 is triggered by the rear end 39B of the tilt shaft 39, the functions of the wheel button are enabled or disabled. Meanwhile, a knock sensing signal is generated from the knock sensor 60. In addition, the spring 61 is deformed and compressed when the rear end 39B of the tilt shaft 39 is moved downwardly, and returns to its original shape due to a restoring force generated from the compressed spring 61. Accordingly, due to the restoring force of the spring 61, the base 41 can be moved upwardly to its original shape after the knock sensor 60 is triggered.

A feature of the present invention includes the tilt sensing module 50. In an embodiment, the tilt sensing module 50 comprises a left portion and a right portion with respect to the scroll wheel assembly 40. The left potion of the tilt sensing module 50 comprises a triggering element 51A and a tilt sensor 52A. The right potion of the tilt sensing module 50 comprises a triggering element 51B and a tilt sensor 52B. The triggering elements 51A and 51B are mounted above the tilt sensors 52A and 52B, respectively. The tilt sensors 52A and 52B are fixed on the inner surface of the lower housing 30A. The triggering elements 51A and 51B have several fixing pins 511A, 512A, 511B and 512B, which are anchored on the inner surface of the lower housing 30A according to a welding technology for example.

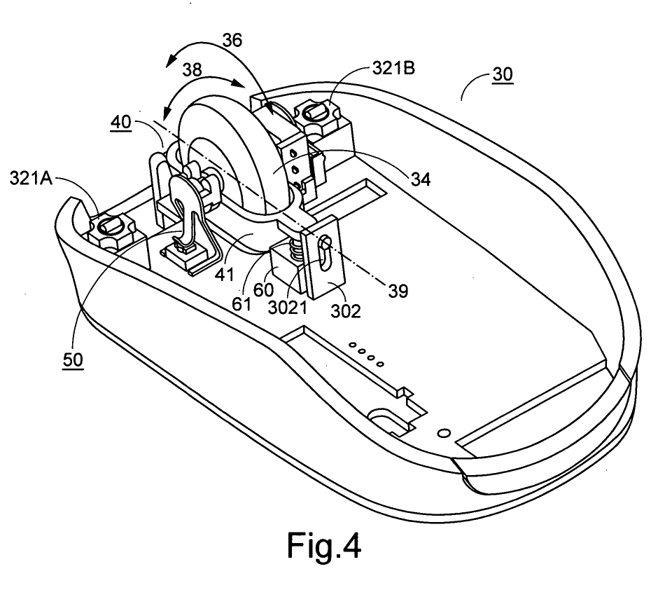

Please refer to FIG. 4, which is a schematic assembled view partially illustrating the inner structure of the tilt wheel type mouse 30. As shown in FIG. 4, the left and right portions of the tilt sensing module 50 are arranged at bilateral sides of the scroll wheel assembly 40. The scroll wheel 34 of the mouse 30 can be rotated forwardly or backwardly as shown in the arrows 36, thereby scrolling the image shown on the display screen upwardly and downwardly. In addition, due to cooperation of the spring 61, the rear supporting member 302 and the sliding slot 3021, the scroll wheel 34 and the base 41 can be moved upwardly and downwardly in the vertical direction. When the top button 62 of the knock sensor 60 is triggered by the rear end 39B of the tilt shaft 39, the functions of the wheel button are enabled or disabled. Moreover, the scroll wheel 34 can be tilted toward the left or right side as shown in the arrows 38 along the tilt shaft 39 to enable the function of the tilt wheel. The operation principle of the tilt wheel will be illustrated later.

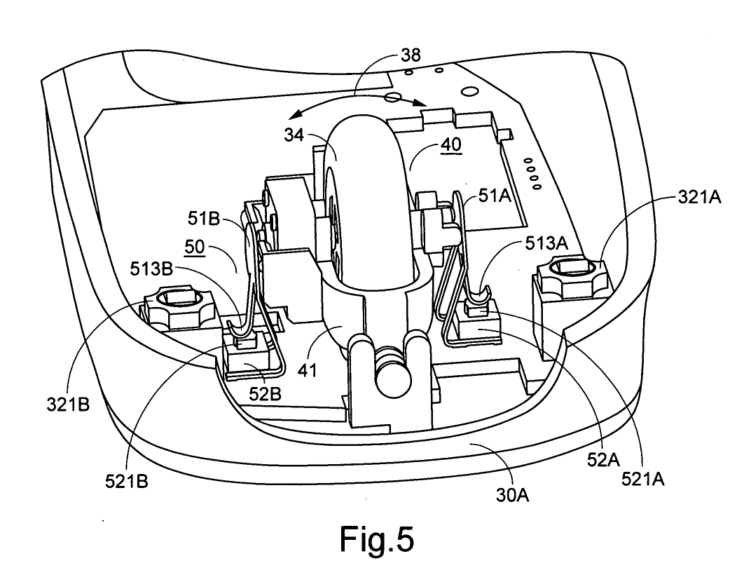

Please refer to FIG. 5, which is a schematic assembled view of FIG. 4 taken from another viewpoint. The relative location between the tilt sensing module 50 and the scroll wheel assembly 40 is another feature of the present invention. In this embodiment, the left and right portions of the tilt sensing module 50 are arranged at bilateral sides of the scroll wheel assembly 4. According to a precise mechanical design, the triggering element 51A (or 51B) is kept at least a certain clearance from the scroll wheel assembly 40 even when the scroll wheel assembly 40 is moved in the vertical direction. That is, when the scroll wheel 34 and the base 41 are moved upwardly and downwardly in the vertical direction, the periphery of the base 41 is not in direct contact with the triggering elements 51A and 51B. Whereas, when the scroll wheel assembly 40 is tilted toward the left or right side, the clearance is shrunk such that the scroll wheel assembly 40 touches the triggering element 51A or 51B. Accordingly, the tilt sensor 52A or 52B is triggered by the triggering element 51A or 51B.

Please refer to FIG. 5 again. The triggering elements 51A and 51B are fixed on the inner surface of the lower housing 30A. The triggering elements 51A and 51B have respective triggering pins 513A and 513B. It is preferred that the fixing pins 511A, 512A are integrally formed with the triggering pin 513A and the fixing pins 511B, 512B are integrally formed with the triggering pin 513B. In this embodiment, the triggering elements 51A and 51B are flexible sheets. After the scroll wheel 34 is tilted toward the left or right side with the tilt shaft 39 serving as a pivoting axis, the triggering pin 513A or 513B may touch the top button 521A or 521B of the tilt sensor 52A or 52B. According to the deformation degree of the triggering element 51A or 51B upon the top button 521A or 521B of the tilt sensor 52A or 52B is touched, the tilt sensors 52A or 52B is triggered to generate a tilt sensing signal.

Moreover, as shown in FIGS. 3, 4 and 5, the inner structure of the tilt wheel type mouse 30 further comprises two click button sensors 321A and 321B corresponding to the click buttons 32A and 32B, respectively. The click button sensors 321A and 321B and the click buttons 32A and 32B are combined as a click button module. The click button sensor 321A are 321B are triggered to generate click button sensing signals upon the click buttons 32A and 32B are pressed down, respectively, so as to execute the same functions as the left and right buttons of the conventional mouse.

Moreover, the inner structure of the tilt wheel type mouse 30 further comprises a movement sensing module and a processing control module (not shown). Like the conventional optical mouse or trackball mouse, the movement sensing module of the tilt wheel type mouse 30 has a displacement sensor to detect the displacement data of the main body 300 relative to a smooth plane, for example a surface of a table. According to the displacement data, a movement sensing signal is generated. On the other hand, the processing control module is also disposed within the main body 300, and communicable with the scroll wheel assembly 40, the tilt sensing module 50, the knock sensor 60, the movement sensing module, the click button module and the computer system (not shown). In response to actuating operations of these modules or the corresponding signals such as the rotation sensing signal, the knock sensing signal, the tilt sensing signal, the click button sensing signal and the movement sensing signal, the processing control module performs corresponding signal processing operations so as to control the cursor of the computer system. Under this circumstance, the computer system and the tilt wheel type mouse 30 are cooperatively used to browse the window of a web page, a document or a trial balance.

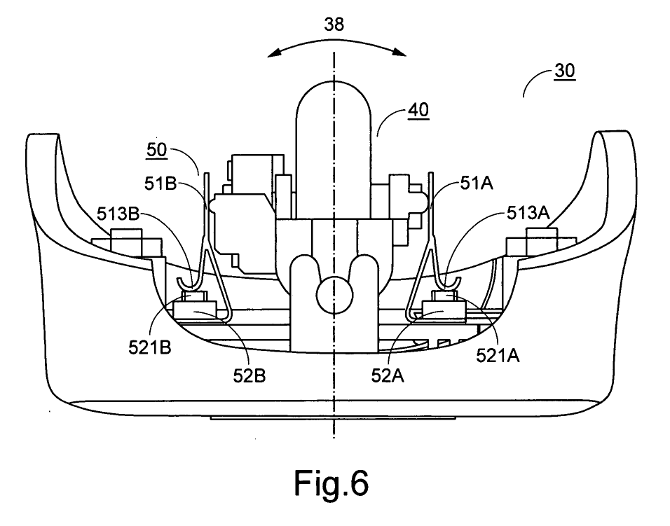

Please referring to FIG. 6, which is a schematic front view illustrating the inner structure of the tilt wheel type mouse 30. When the scroll wheel assembly 40 is moved upwardly and downwardly in the vertical direction, the periphery of the scroll wheel assembly 40 is not in direct contact with the triggering elements 51A and 51B of the tilt sensing module 50, so that the tilt sensor 52A or 52B is not triggered by the triggering element 51A or 51B. Whereas, when the scroll wheel assembly 40 is tilted toward the left or right side as shown in the arrows 38, the clearance is shrunk such that the scroll wheel assembly 40 touches the triggering element 51A or 51B. Moreover, since the triggering elements 51A and 51B are flexible sheets, the triggering elements 51A and 51B are designed to deform when a sufficient external force is applied thereon. According to the deformation degree of the triggering pin 513A or 513B upon the top button 521A or 521B of the tilt sensor 52A or 52B is touched, the tilt sensors 52A or 52B is triggered to generate the tilt sensing signal. Since the tilt sensors 52A or 52B is triggered when the external force reaches a sufficient strength, the problem of causing erroneous operation of the tilt sensor due to improperly depressing force applied onto the scroll wheel will be overcome.

From the above description, the cursor control device of the present invention is capable of quickly scrolling the image displayed on the window of the display screen in the vertical direction by means of the scroll wheel assembly 40 and quickly scrolling the image displayed on the window of the display screen in the horizontal direction by means of the tilt sensing module 50. In addition, since the problem of causing erroneous operation of the tilt sensor is overcome, the speed for scrolling the scroll bar beside the window or browsing the web page or the document is increased.

The present invention is illustrated by referring to a mouse. Nevertheless, the present invention can be applied to other cursor control device such as a trackball.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A cursor control device for use with a computer system, comprising:
a main body;
a scroll wheel assembly disposed within said main body, and operable to move in a vertical direction and tilt toward a first tilt direction; and
a tilt sensing module disposed within said main body and comprising a first triggering element and a first tilt sensor, said first triggering element being disposed above said first tilt sensor, wherein said first triggering element is kept at least a certain clearance from said scroll wheel assembly even when said scroll wheel assembly is moved in said vertical direction, and said clearance is shrunk when said scroll wheel assembly is tilted toward said first tilt direction to touch said first triggering element so as to trigger said first tilt sensor.

2. The cursor control device according to claim 1 further comprising:
a movement sensing module disposed within said main body, and having an optical or trackball type displacement sensor for detecting the displacement data of said main body relative to a smooth plane, thereby generating a movement sensing signal;
a click button module comprising at least one click button and at least one click button sensor, wherein said at least one click button sensor is triggered when said corresponding click button is pressed down; and
a processing control module disposed within said main body, and communicable with said scroll wheel assembly, said tilt sensing module, said movement sensing module, said click button module and said computer system, wherein said scroll wheel assembly, said tilt sensing module, said movement sensing module and said click button module are actuated to issue corresponding signals to said processing control module, and in response to said signals, said processing control module performs corresponding signal processing operations so as to control a cursor of said computer system.

3. The cursor control device according to claim 2 wherein said scroll wheel assembly comprises:
a base having a tilt shaft thereon, wherein said tilt shaft includes a front end movably supported on a front supporting member of said main body and a rear end rear end movably embedded into a sliding slot of a rear supporting member of said main body, so that said base is movable in said vertical direction along said sliding slot of said rear supporting member and tilted toward said first tilt direction with said tilt shaft serving as a pivoting axis;
a scroll wheel disposed on said base, movable in said vertical direction with said base, and rotatable along a rotating shaft; and
a rotation sensor supported on said base, and communicating with said processing control module to generate a rotation sensing signal according to the rotating degree of said scroll wheel, wherein in response to said rotation sensing signal, said processing control module performs corresponding signal processing operation to control said cursor of said computer system.

4. The cursor control device according to claim 3 further comprising:
a knock sensor disposed under said rear end of said tilt shaft and communicating with said processing control module; and
a resilient element sustained between said rear end of said tilt shaft and said knock sensor to apply an upward resilient supporting force onto said base,
wherein a knock sensing signal is generated from said knock sensor when said base is moved and said knock sensor is triggered by said rear end of said tilt shaft, and in response to said knock sensing signal, said processing control module performs corresponding signal processing operation to control said cursor of said computer system.

5. The cursor control device according to claim 3 wherein said tilt sensing module is disposed at a side of said base where base is tilted toward said first tilt direction.

6. The cursor control device according to claim 3 wherein said first triggering element is kept at least said certain clearance from said scroll wheel assembly allowing no touch between said base of said scroll wheel assembly and said first triggering element when said scroll wheel assembly is moved in said vertical direction.

7. The cursor control device according to claim 3 wherein said first triggering element is disposed within said main body and has a triggering pin to touch said first tilt sensor under said first triggering element.

8. The cursor control device according to claim 7 wherein said first triggering element is a flexible sheet deformed when said base is tilted toward said first tilt direction to touch said first triggering element, and said first tilt sensor is triggered to generate a tilt sensing signal according to the degree of said first triggering element when said triggering pin of said first triggering element touches said first tilt sensor, wherein in response to said tilt sensing signal, said processing control module performs corresponding signal processing operation to control said cursor of said computer system.
